(19) United States
(12) Patent Application Publication
(10) Pub. No.: US 2016/0180283 A1
(43) Pub. Date: Jun. 23, 2016

(54) PHYSICAL ITEM RECONCILIATION

(71) Applicant: Microsoft Technology Licensing, LLC, Redmond, WA (US)

(72) Inventors: Abhishek Ghosh, Copenhagen (DK); Mirza Abdic', Copenhagen (DK); Lennart Conrad, Copenhagen (DK)

(21) Appl. No.: 14/575,055

(22) Filed: Dec. 18, 2014

(51) Int. Cl. G06Q 10/08

(52) U.S. Cl. CPC G06Q 10/087

(57) ABSTRACT

A system for reconciling physical items in a facility is provided. The system includes a data store containing item information relative to items stored within the facility. A processor is coupled to the data store and is configured to perform at least one control function relative to the items. A user interface component is coupled to the processor and is configured to receive information defining a cycle count relative to at least some items stored within the facility. A network component is coupled to the processor and is configured to convey container information to a plurality of terminals based on the defined cycle count. A virtual count engine is configured to receive observation data from the plurality of terminals associated with the container information. The virtual count engine is configured to group the observation data according to item identifiers and compare the grouped information with information maintained in the data store.

### BACKGROUND

Large facilities such as supermarkets, hypermarkets and warehouses provide the ability for economies of scale to reduce the costs of items that are sold or processed by such facilities. In some cases, such a facility may house over 200,000 different brands of merchandise. Further, there may be 1000's of items for each brand. Accordingly, while the efficiencies provided by such large facilities are very beneficial, effective management of such facilities is daunting. This is even more so in situations where some of the items are perishable and/or have relatively short shelf-lives.

In order to effectively manage such large facilities, it is generally useful to employ a computerized management system. The computerized management system is adept at tracking all of the items relative to the facility, a group of facilities, or even an entire enterprise.

Ideally, all of the information reflected in the computerized management system would be matched to the physical reality of the facility. However, the realities of day-to-day operations often have various items move about and thus, the information reflected in the computerized management system may not be indicative of the physical reality in the facility. For example, a consumer in a retail store may select an item to purchase and place it in his/her cart, walk through the facility, find a different item, and decide not to purchase the first item. In some instances, the consumer will simply set the first item on a shelf and continue shopping. In another example, a warehouse worker may place a group of items in an erroneous location within the warehouse. In each case, the physical reality in the facility is no longer accurately reflected by the computerized management system, which has no indication that such movement has occurred.

Accordingly, operators of such large facilities, will periodically (typically 3-4 times per year) perform a large scale operation where the physical items in the facility are counted and reconciled with the information in the computerized management system. Generally, this operation involves a small team of workers who spend days walking through the facility, counting and recording items. In this way, the computerized management system is periodically trued up to the physical reality in the facility.

The discussion above is merely provided for general background information and is not intended to be used as an aid in determining the scope of the claimed subject matter.

### SUMMARY

A system for reconciling physical items in a facility is provided. The system includes a data store containing item information relative to items stored within the facility. A processor is coupled to the data store and is configured to perform at least one control function relative to the items. A user interface component is coupled to the processor and is configured to receive information defining a cycle count relative to at least some items stored within the facility. A network component is coupled to the processor and is configured to convey container information to a plurality of terminals based on the defined cycle count. A virtual count engine is configured to receive observation data from the plurality of terminals associated with the container information. The virtual count engine is configured to group the observation data according to item identifiers and compare the grouped information with information maintained in the data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a facility with which embodiments described herein are particularly applicable.

FIG. 2 is a diagrammatic view of a computerized management system in accordance an embodiment.

FIG. 3 is a diagrammatic illustration of a user interface of a control application in accordance with an embodiment.

FIG. 4 is a diagrammatic view of virtual count (VC) terminal with which embodiments described herein are particularly applicable.

FIG. 5 is a diagrammatic view of a VC terminal being used to acquire product observations relative to a plurality of items on a shelf in a facility in accordance with an embodiment.

FIG. 6 is a flow diagram of a method of automatically determining and recording a geolocation of an observation in accordance with an embodiment.

FIG. 7 is a flow diagram of a method of performing a physical item reconciliation for a facility in accordance with an embodiment.

FIG. 8 is a diagrammatic view of a VC terminal providing guidance information on its display screen in accordance with an embodiment.

FIG. 9 provides a general block diagram of the components of a client device that can run components of VC terminals and/or application platform in accordance with one embodiment.

FIG. 10 shows a VC terminal embodied as a tablet computer in accordance with one embodiment.

FIG. 11 is one embodiment of a computing environment in which system 110, or parts of it, for example, can be deployed.

### DETAILED DESCRIPTION

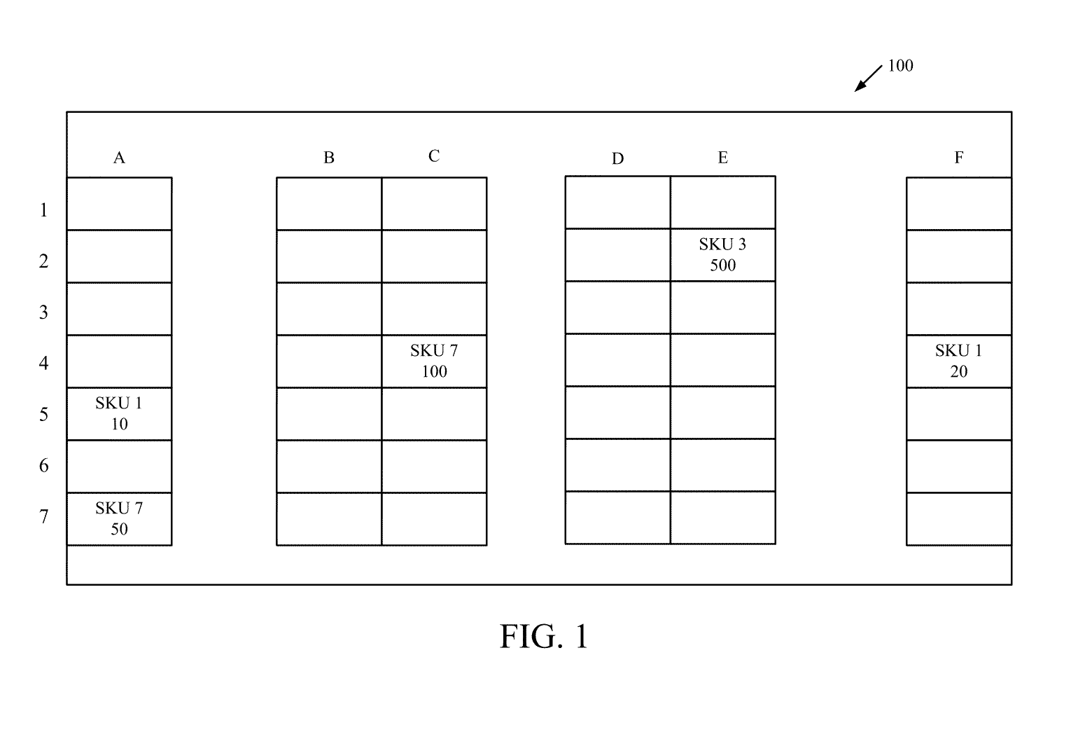

FIG. 1 is a diagrammatic view of a facility with which embodiments described herein are particularly applicable. For simplicity, facility 100 is shown having shelves A, B, C, D, E, and F with positions 1-7 available on each shelf. In reality, facility 100 may have hundreds of isles with multiple shelves in each isle and hundreds of positions available on each shelf. Further, facility 100 may be one of many facilities operated by an enterprise.

As shown in FIG. 1, items having an item identification “SKU1” are shown being housed at position A-5. As indicated, ten of such items are stored at that position. Additionally, 20 of the same item (SKU1) are also stored at location F-4 in facility 100. As further shown in FIG. 1, items having an identifier SKU7 are shown in positions A-7 and C-4. Finally, FIG. 1 shows item SKU3 located at position E-2 having a quantity of 500 items.

As used herein, an “item identifier” is a unique identification of a particular item configuration such that all items having the same item identifier are identical. For familiarity in the description, these are described as Stock Keeping Units or “SKUs”, however any suitable item identifier can be used in accordance with embodiments with the present invention. Such item identifiers include, without limitation, Universal Product Code (UPC), International Article Number (EAN), Global Trade Item Number (GTIN), and Australian Product Number (APN).

Occasionally, various items will be moved from one location in facility 100 to another without the change of location being reflected in a computerized management system of the facility. Accordingly, operators of the facility will periodically perform an operation where a team of workers (such as 50-70 workers) will move through the facility, identify and count various items located in the facility, and record their information. In the past, this has been a relativity laborious process where each worker on the team generally had a pen and paper and simply recorded the information that they observed. Upon completion of the task, all of the recorded information from the workers was entered into the computerized management system. In the event that there was a discrepancy, the particular observation that gave rise to the discrepancy would not be known. Moreover, it was generally impossible to back-track to the place in the facility where the observation that gave rise to the discrepancy occurred. Thus, when a discrepancy occurred, an investigation would generally be required into items of that particular item identifier such that further interaction with the computerized management system and/or physical items could be performed. For example, the total count of item SKU1 might be 30 items, but the computerized management system might indicate that the facility is supposed to house 32 of said items. Given that the workers had observed 10 of said items in location A-5 and 20 of said items in location F-4, it was generally not apparent where the discrepancy occurred. Moreover, if items were found in locations that did not correspond to shelving positions, the location of such items would not be recorded. This further complicated an arduous task.

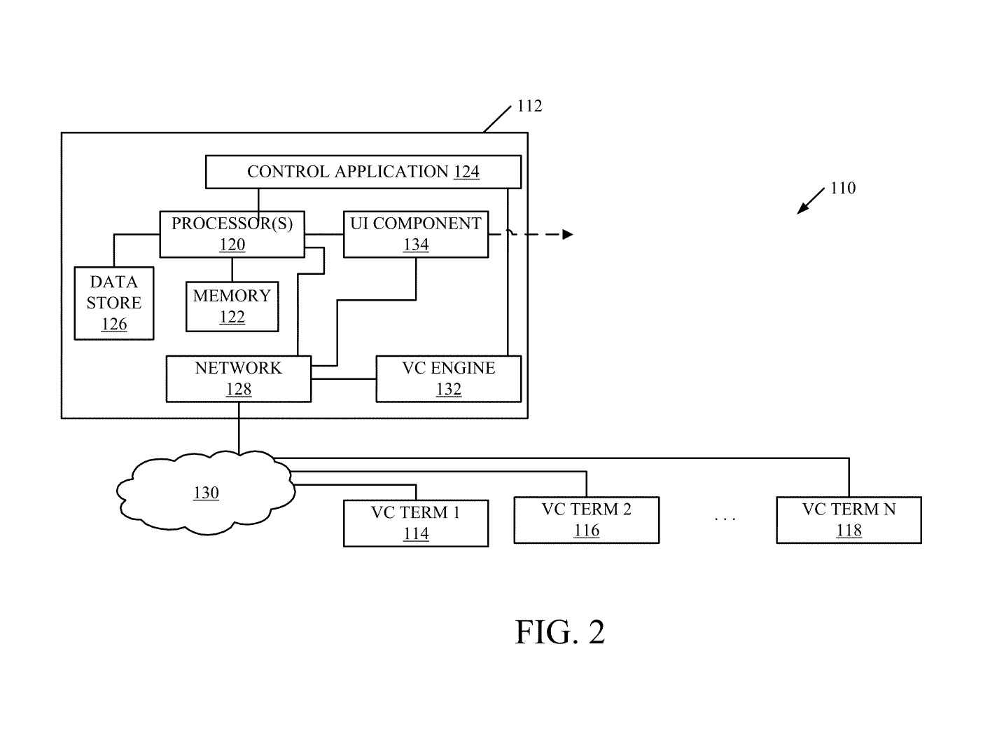

FIG. 2 is a diagrammatic view of a computerized management system in accordance an embodiment. System 110 generally includes application server platform 112 communicatively coupled to a plurality of virtual count (VC) terminals 114, 116 and 118. Application server platform 112 may be embodied on one or more general purpose computers that are located on the premises of facility 100, or remotely therefrom, such as in a cloud implementation.

Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 110 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure. A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, et cetera.

Application server platform 112 generally includes one or more processors 120 coupled to suitable memory 122. Processor(s) 120 executes a number of instructions stored in memory 122 in order to provide one or more control applications 124. Control applications 124 provide specific functionality relative to the facility. For example, one function may be tracking or otherwise maintaining items stored by the facility. For example, if the count of a particular item stored within the facility is reduced to a particular threshold, control application 124 may automatically generate an order for additional items. Similarly, if the quantity of a particular item is above a particular threshold for a selected amount of time, application 124 may trigger the facility to offer a closeout or incentive for consumers to purchase more of that particular item.

Processor(s) 120 is communicatively coupled to data store 126, which can include any suitable database or data structure that is able to effectively store information relative to the facility. In one example, data store 126 may be a group of object relational databases configured to store information relative to the facility.

Application server platform 112 also includes network component 128 that allows application server platform 112 to provide information to external devices. For example, network component 128 couples application server platform 112 to a communication network, such as a local area network (LAN), a wide area network (WAN), such as the internet 130, or any combination thereof. Further, in embodiments where internet 130 is employed to communicatively couple application server platform 112 to VC terminals 114, 116 and 118, is expressly contemplated that one or more encrypted virtual private networking tunnels between terminals 114, 116 and 118 can be used to communicatively couple VC terminals 114, 116 and 118 to application server platform 112 through internet 130.

As set forth above, at least one of the functions provided by control application 124 is the storage and maintenance of information relative to physical items housed or otherwise processed by facility 100. When the operation of reconciling the physical items with the information stored in data store 126 is required, control application 124 employs virtual count (VC) engine 132 to define one or more virtual count tasks; provide information to one or more of VC terminals 114, 116 and 118 relative to the defined task(s); and receive count information from the VC terminals 114, 116 and 118. VC engine 132 is configured through hardware, software, or a combination thereof, to process the information received from VC terminals 114, 116 and 118 into a format that can be effectively compared with information stored in data store 126. Then, VC engine 132 performs such comparison and generates a discrepancy list that is indicative of discrepancies between the physical counts observed, as recorded in VC terminals 114, 116 and 118 and information stored in data store 126. This discrepancy information can be provided to one or more operators or workers either via UI component 134 or through an automatic notification to one or more responsible parties through network component 128. For example, an electronic message or other suitable data could be transmitted to one or more parties in order to investigate discrepancies and/or remedy the discrepancy.

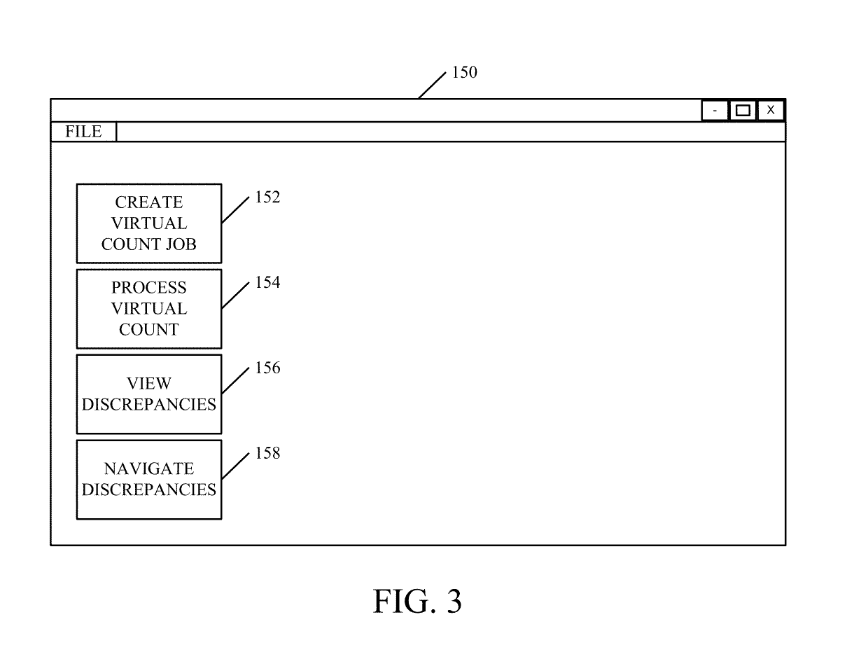

FIG. 3 is a diagrammatic illustration of a user interface of control application 124 in accordance with an embodiment. User interface 150 includes a plurality of user interface elements 152, 154, 156 and 158. User interface 150 may be generated locally at application server platform 112 or remotely therefrom, such as by UI component 134 providing a user interface in a form of webpage (HTTP) information that is viewable by one or more users communicatively coupled to application server platform 112 via network component 128.

User interface component 152 allows a user thereof to create a virtual count job. When a virtual cycle count job is defined, control application 124 generates a container object or other suitable data structure that is provided to each of the VC terminals that are enlisted for the count. Each VC terminal then associates observation data with the virtual count container as the terminal acquires observation data.

The creation of the virtual cycle count can be defined relative to all item stored at facility 100, or any subgroup that may be defined by the user. Exemplary subgroups include subgroups based on specific locations or regions within facility 100, item type, or any other suitable criteria. Additionally, user interface element 152 may be used to define different virtual cycle count jobs to be assigned to different virtual count terminals. Accordingly, multiple distinct teams of workers with substantially identical VC terminals may be working on different virtual cycle count jobs simultaneously. Further, individual workers may be associated with individual terminals such that observation data from a particular terminal can be related to a particular worker.

Once the physical observations have been completed, the virtual cycle terminals, such as terminals 114, 116, and 118 provide their observation data to VC engine 132 when a user of interface 150 engages user interface element 154. When this occurs, application server platform 112, through VC engine 132 and network component 128, will query or otherwise engage the various VC terminals for which the user interface element 154 has been engaged in order to receive the observation data from those terminals. Once all observation data has been received from all terminals, VC engine 132 groups the data according to item identifiers while maintaining position information relative to each observation. The total for each group is then compared by control application 124 to information stored in data store 126 relative to each item identifier of the virtual cycle count. In the event that a discrepancy exists between the information in data store 126 and the sums of the grouped item identifiers, application server platform 112 can direct a worker to return to one or more of the observation locations in order to resolve the discrepancy. This indication can be provided in the form of a user simply viewing discrepancies by engaging user interface component 156. Additionally, or alternatively, such discrepancies can be provided to one or more responsible parties via any suitable electronic communication through network component 128 in order to direct the responsible parties to one or more of the observation locations which gave rise to the discrepancy. Moreover, discrepancy resolution notifications can be grouped according to location such that a particular worker, directed to a region in order to resolve discrepancies, can be tasked with resolving a number of observation discrepancies that occurred within a particular area. In one embodiment, a user of interface 150 may select navigate discrepancies interface element 158. This navigation information can be indicated on a computer screen and/or sent to one or more VC terminals 114, 116, and 118 in order to direct workers to the locations of the observations that gave rise to the discrepancy.

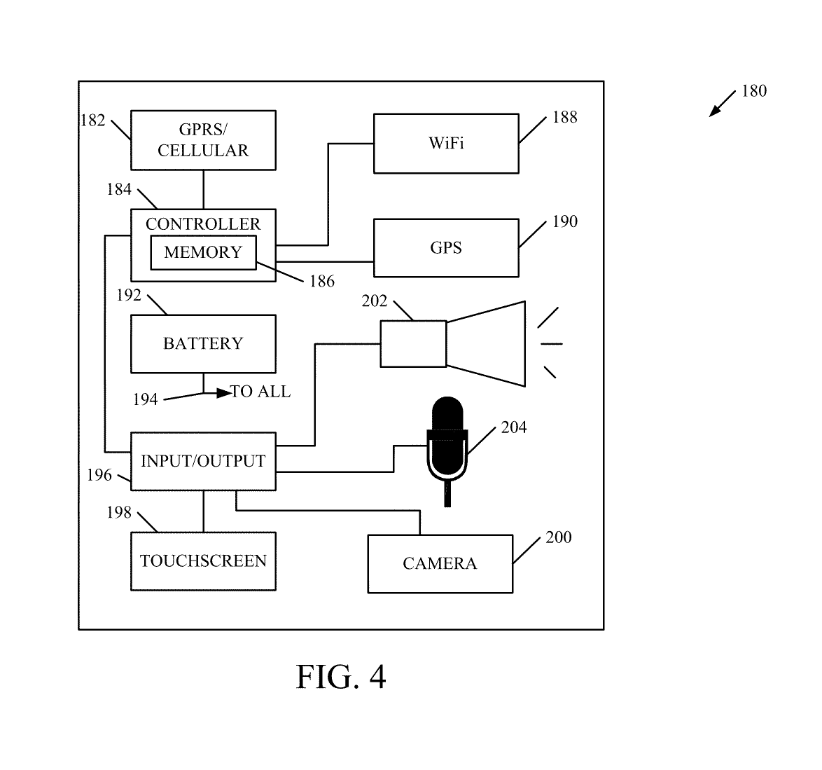

FIG. 4 is a diagrammatic view of VC terminal 180 in accordance with which embodiments are particularly applicable. While VC terminal 180 may be a purpose-built device, such as a wirelessly-connected barcode scanner, embodiments of the present invention are particularly useful when VC terminal is embodied on a smartphone. This is because the typical number of workers used to perform the reconciliation operation and the frequency with which the operation must generally be accomplished is generally not sufficient to justify the expense of enough purpose-built devices (which may cost on the order of $2,000 to $3,000) for each worker given that a team of 50 or more may be used. However, as smartphones are becoming ubiquitous, embodiments of the present invention are generally able to leverage the hardware carried by various workers in order to perform virtual cycle counting jobs. Accordingly, VC terminal 180 includes components that are typically embodied within a smartphone. However, additional components may be included as desired. Moreover, VC terminal 180 need not be a smartphone, but may be any suitable device that has the components shown in FIG. 4, such as a tablet or phablet.

VC terminal 180 includes a GPRS/cellular communication module 182 that is configured to communicate to known cellular communication technologies. Examples of such communication include GPRS, GSM, and LTE. GPRS/cellular communication module 182 is coupled to controller 184 to allow controller 184 to communicate over a cellular communication network. Controller 184 may be any suitable device that is able to programmatically execute a sequence or set of instructions in order to perform the virtual cycle counting operations set forth below. Controller 184 may include or be coupled to suitable memory 186 that stores program information, applications, an operating system, device configuration information, and observation data. Memory 186 includes nonvolatile memory, as well as some form of volatile memory. Controller 184 is also coupled to Wi-Fi communication module 188 that allows VC terminal 180 to communicate in accordance with the known Wi-Fi communication protocols. Wi-Fi is a local area wireless technology that allows VC terminal 180 to communicate or exchange data or connect to a data communication network, such as the internet, using unregulated spectrum. For example, Wi-Fi currently employs 2.4 GHz signals and/or 5 GHz signals. Further still, Wi-Fi technology is well-developed with consumer devices being widely available.

Controller 184 is also coupled to GPS module 190, which is configured to interact with the Global Positioning System (GPS) in order to identify a geo-location of VC terminal 180 based on signals received from a plurality of satellites.

VC terminal 180 also includes a battery 192 that is configured to provide power “to all” components of VC terminal 180 as indicated by arrow 194. Preferably, battery 192 is a rechargeable battery. Controller 184 is also coupled to input/output module 196 that interfaces controller 184 to various input/output devices. One example of an input/output device is touch screen 198 that functions both as a display of VC terminal 180, and a user input mechanism. Touch screen 198 will provide an indication indicative of user touches on the screen as well as the location of the touch on the screen. Input/output module 196 is also coupled to camera 200. Camera 200 may include any suitable image acquisition device, such as a charged coupled device (CCD) or a complementary metal oxide semiconductor (CMOS) image acquisition device. Camera 200 allows VC terminal 180 to acquire one or more images relative to the observations during the virtual cycle count. Input/output module 192 is also coupled to external speaker 202 and microphone 204 in order to allow VC terminal 180 to generate and respond to sounds. For example, microphone 204, in combination with suitable processing techniques, allows VC terminal 180 to recognize user speech such that spoken commands may be valid user input for VC terminal 180.

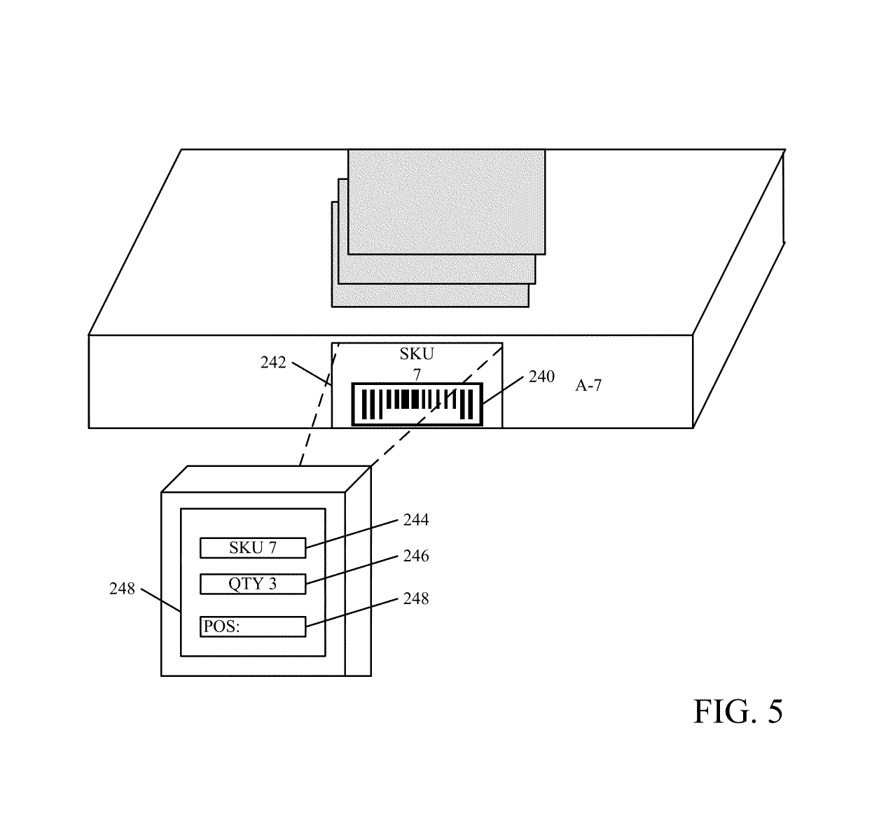

FIG. 5 is a diagrammatic view of VC terminal 180 being used to acquire observation data relative to a plurality of items on a shelf in a facility in accordance with an embodiment. As indicated, a worker has arrived at location 7 on shelf A. At that location, the items are identified as item SKU 7. Additionally, a barcode 240 may be present on the item identification tag 242 such that the item identifier can be acquired automatically by VC terminal 180. In such instance, an application executed by VC terminal 180 engages camera 200 of VC terminal 180 to acquire an image of barcode 240 and process barcode 240 to extract item identification information therefrom. For example, the processed barcode may indicate that the item identifier is SKU 7. Additionally, or alternatively, a user of VC terminal 180 may simply speak the item identifier to VC terminal 180. Finally, the worker may simply manually enter the item identifier into field 244 by virtue of a soft keypad, or any other suitable user input device.

With the item identifier entered into field 244, the worker will count the number of items present at that location and enter the number of items into field 246. Again, this data entry may be performed by the user speaking to VC terminal 180 or manually entering the information into VC 180 via a soft keypad. Finally, as indicated by field 248, VC terminal 180 is configured to store a position relative to the observation. In one embodiment, this position information may be an entry of the shelf and location where the observation was performed. For example, A-7 may be entered into field 248 by the worker either speaking the location or manually entering the location via a soft keypad or the like. However, in another embodiment, VC terminal 180 will automatically acquire and record the geolocation of the observation based on one or more position indicating operations performed by VC terminal 180. This automatic position information acquisition and storage is useful in that it reduces human interaction with VC terminal 180 thereby also potentially reducing the possibility for human error.

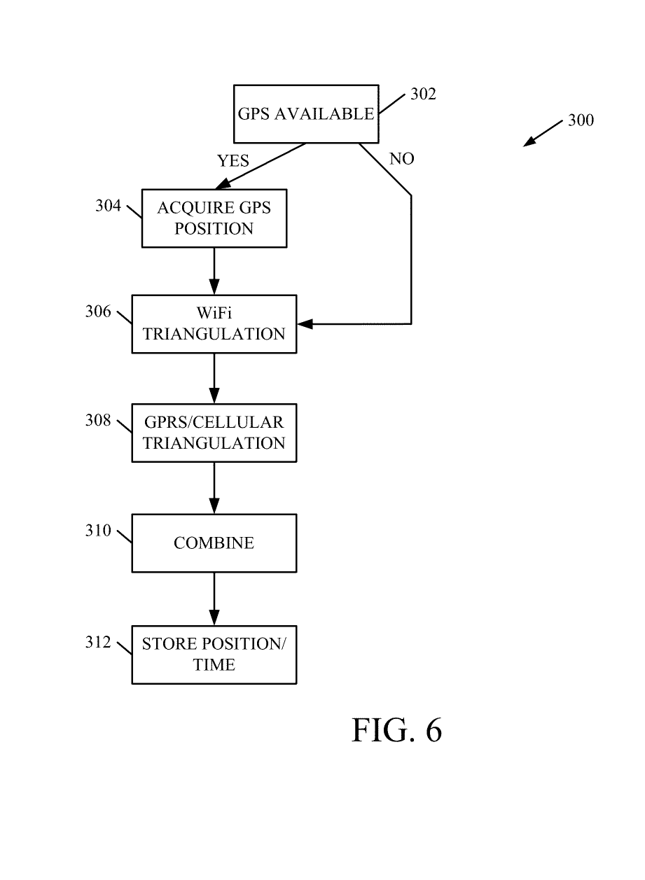

FIG. 6 is a flow diagram of a method of automatically determining and recording a position of an observation in accordance with an embodiment of the present invention. Method 300 begins at block 302 where controller 184 of VC terminal 180 determiners whether a GPS signal is available by virtue of interacting with GPS module 190. Given that most virtual cycle count operations will occur indoors, the availability of a robust satellite signal may not be available. If a GPS signal is available, control proceeds to block 304 where VC terminal 180 acquires geolocation information from the available GPS signal. Additionally, in some embodiments, VC terminal 180 may also acquire time stamp information from the available GPS signal information. As used herein, GPS signals include signals from a traditional GPS system, as well as signals from a differential GPS system. A differential GPS system is an enhancement to the traditional global positioning system that provides improved location accuracy from the traditional 15 meter GPS accuracy to approximately 10 centimeters. A differential GPS system typically requires an additional stationary receiver with a known position. However, as set forth above, obtaining GPS signals indoors can be limited. Accordingly, in situations where a GPS signal is not available, control proceeds directly from block 302 to block 306. At block 306, VC terminal 180 employs module 188 to identify Wi-Fi signals from a plurality of Wi-Fi access points or stations having known locations in order to determine geolocation information based on triangulation of Wi-Fi signals. The operator of facility 100 can facilitate Wi-Fi triangulation by installing more Wi-Fi access points or stations at known positions throughout the facility. In this way, even in the absence of a GPS signal, geolocation information can be determined automatically with accuracy. However, in some facilities the number of Wi-Fi access points may be limited such that triangulation cannot be performed with sufficient accuracy. Accordingly, embodiments also include VC terminal 180 using GPRS/cellular module 182 in order to interact with cellular signals to perform cellular triangulation 308. Finally, at block 310, the geolocation information from block 304, if available, is combined with geolocation information from Wi-Fi triangulation 306 and geolocation information from cellular triangulation 308. The geolocation information from the various sources can be weighted in any suitable manner or they may be simply averaged. The result at block 310 is a geolocation of VC terminal 180 being determined based on one or more of the geolocation information providers relative to the observation. At block 312, the automatically-determined geolocation of VC terminal 180 is stored in field 248 (shown in FIG. 5). Additionally, the time and date of the observation is also preferably stored.

While embodiments described herein are particularly applicable to automatically obtaining and storing geolocation information relative to observations performed during a virtual cycle count, embodiments are applicable to automatic geolocation acquisition in storage relative to any item of interest maintained by the facility. For example, in a large logging operation, a stack of logs deposited in a field adjacent to a facility can have its geolocation automatically recorded and stored along with a count of the number of logs at that location.

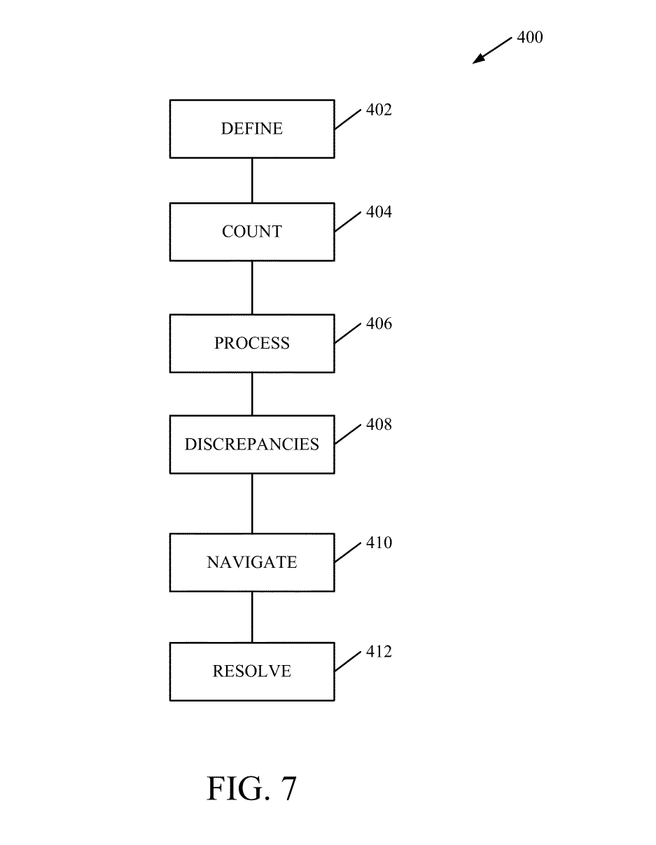

FIG. 7 is a flow diagram of a method of performing physical item reconciliation for a facility in accordance with an embodiment. Method 400 begins at block 402 where a virtual cycle count job is defined. As set forth above, the job may be defined for all items housed by the facility, or any suitable subgroup based on any suitable criteria, such as location or item type. At block 402, the defined virtual cycle count job container object is provided to one or more VC terminals in any suitable manner, such as through a local area network or wide area network. Next, at block 404, the various VC terminals are used by workers to enter count information into an application on the VC terminal in a suitable position, such as field 246. A location relative to the observed count is either determined automatically (geolocation) and stored by a VC terminal or entered by a worker. Once this process been completed for all items included in the virtual cycle count, control passes to block 406 where the virtual cycle count job is processed. At block 406, the various VC terminals which are enlisted in the virtual cycle count job, defined at block 402, provide their stored count to VC engine 132. VC engine 132 then groups the observed count information based on item identifiers, such as SKUs, to arrive at total counts for each unique item identifier. Then, VC engine 132 provides this information to control application 124 which compares the virtual cycle count information with information stored in data store 126 (shown in FIG. 2). Based on this comparison, at block 408, one or more discrepancies are identified between the observed counts and the information stored in data store 126. However, because each observation is tagged with a specific position or geolocation of the observation, discrepancies can be resolved by returning to a location that generated the discrepancy to verify that the observation is correct, and/or change the information stored in data store 126. Accordingly, as indicated at block 410, navigation information may be generated to facilitate returning to the observation location that generated the discrepancy. In one embodiment, this navigation information is provided to one or more VC terminals 114, 116, and 118 to allow a worker carrying such VC terminal to be guided to the respective position. Finally, at block 412, once the worker has returned to the location of the observation that generated the discrepancy, the discrepancy can be resolved by either remedying the observation data (e.g. by correcting the count), changing the information stored in data store 126, or both. Regardless, the process of physically returning to a location in the facility that generated the discrepancy observation is not only made possible, but is vastly facilitated.

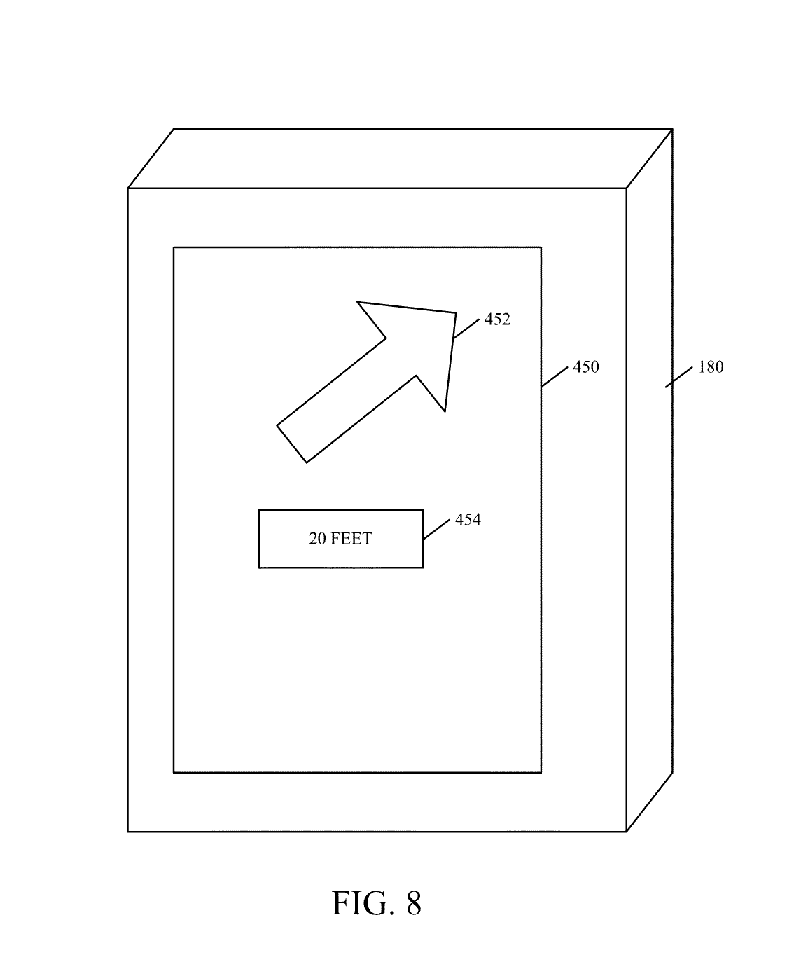

FIG. 8 is a diagrammatic view of a VC terminal 180 providing guidance information on its display screen 450. In one embodiment, when VC terminal 180 is displaying guidance information 452, camera 200 of VC terminal 180 is engaged such that guidance information 452 is overlaid on a video feed continually provided by camera 200. In the example shown in FIG. 8, guidance information is provided in the form of an arrow indicating a heading as well as a distance to target field 454. However, any suitable visual indicators can be used. By providing such an augmented-reality guide to return VC terminal 180 to the location within facility 100 that generated the discrepancy, a user of VC terminal 180 may be more quickly guided to the position. Moreover, in a crowed facility with many positions placed tightly together, an augmented-reality locational guide may highlight an area within the video display in order to show the worker precisely where the items are located. Further still, in embodiments where a user uses camera 200 to scan a barcode in order to obtain item identifier information, the scanned barcode image as well as surrounding image data may be stored by VC terminal 180 such that as a worker is returning, the actual image acquired during the barcode scanning can be returned to the worker in order to more quickly identify the item on a shelf. Additionally, or alternatively, an image of the location may be acquired and stored when the items are deposited on the shelf, such as by a forklift operator. Then, as the VC terminal 180 is brought within a certain proximity of the location, the image stored by the forklift driver may be displayed on VC terminal 180 in order to aid the worker returning to the location.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will also be noted that system 110, VC terminals 114, 116, and 118, or portions thereon, can be disposed on a wide variety of different devices. Some of those devices include servers, desktop computers, laptop computers, tablet computers, or other mobile devices, such as palm top computers, cell phones, smart phones, multimedia players, personal digital assistants, et cetera.

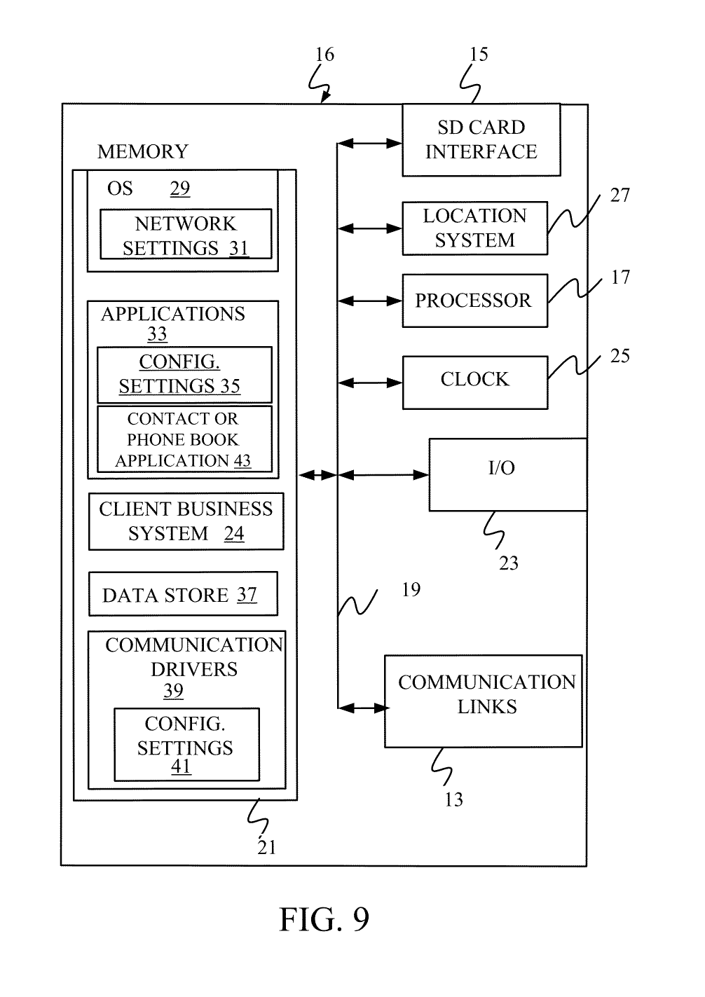

FIG. 9 provides a general block diagram of the components of a client device 16 that can run components of VC terminals 114, 116, or 118 and/or application server platform 112. In device 16, a communications link 13 is provided that allows handheld device 16 to communicate with other computing devices and under some embodiments provides a channel for receiving information automatically. Examples of communications link 13 include an infrared port, a serial/USB port, a network cable port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody controller 184 from FIG. 4) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location or geolocation of device 16. This can include, for instance, a global positioning system (GPS) receiver, a LORAN system, a dead reckoning system, a cellular triangulation system, a Wi-Fi triangulation system and/or other positioning systems. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 126, for example, can reside in memory 21. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

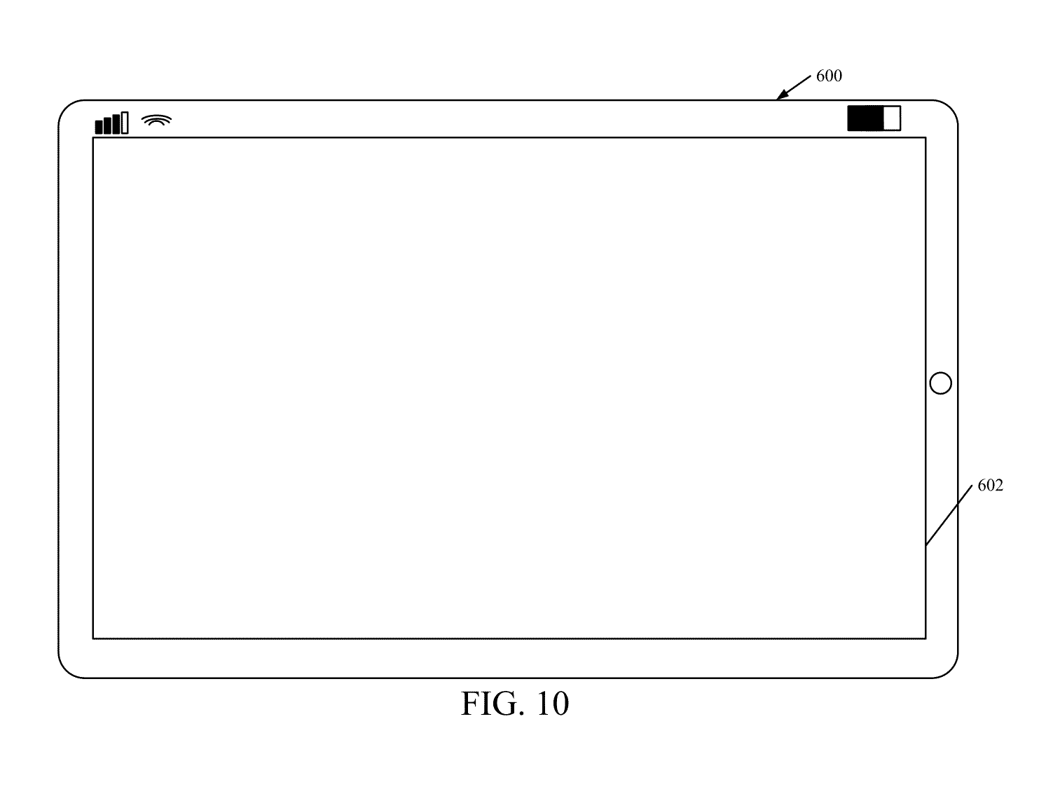

FIG. 10 shows one embodiment in which device 16 is a tablet computer 600. Computer 600 includes display screen 602, which can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

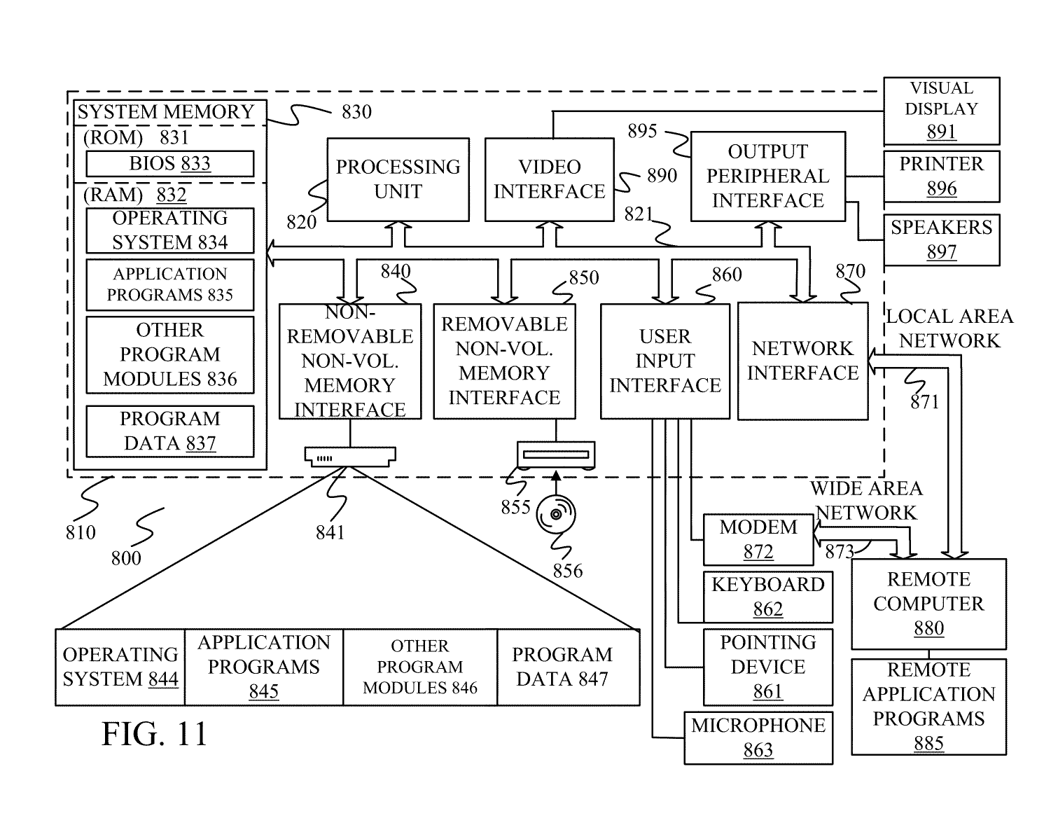

FIG. 11 is one embodiment of a computing environment in which system 110, or parts of it, (for example) can be deployed. With reference to FIG. 11, an exemplary system for implementing some embodiments includes a general-purpose computing device in the form of a computer 810. Components of computer 810 may include, but are not limited to, a processing unit 820 (which can comprise processor(s) 120), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 2 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from and/or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a system for reconciling physical items in a facility. The system includes a data store containing item information relative to items stored within the facility. A processor is coupled to the data store and is configured to perform at least one control function relative to the items. A user interface component is coupled to the processor and is configured to receive information defining a cycle count relative to at least some items stored within the facility. A network component is coupled to the processor and is configured to convey container information to a plurality of terminals based on the defined cycle count. A virtual count engine is configured to receive observation data from the plurality of terminals associated with the container information and is configured to group the observation data according to item identifiers and compare the grouped information with information maintained in the data store.

Example 2 is a system for reconciling physical items in a facility of any or all of the previous examples, wherein the observation data includes count information relative to a unique item identifier as well as location information indicative of a position where the count was observed.

Example 3 is a system for reconciling physical items in a facility of any or all of the previous examples, wherein the location information is geolocation information.

Example 4 is a system for reconciling physical items in a facility of any or all of the previous examples, wherein the system is configured to generate a discrepancy list based on the comparison.

Example 5 is a system for reconciling physical items in a facility of any or all of the previous examples, wherein the discrepancy list includes geolocation information relative to each discrepancy.

Example 6 is a system for reconciling physical items in a facility of any or all of the previous examples, wherein the user interface component is configured to generate a user interface element that when actuated causes the system receive observation data from the plurality of terminals and group the observation data according to unique item identifiers.

Example 7 is a system for reconciling physical items in a facility of any or all of the previous examples, wherein the container information is indicative of a cycle count relative to less than all of the items in the facility.

Example 8 is a system for reconciling physical items in a facility of any or all of the previous examples, wherein the cycle count is defined for a region of the facility.

Example 9 is a computer-implemented method of cycle counting. The method includes receiving container information indicative of a cycle count job, receiving input information indicative of an item identifier, receiving count information indicating a number of items viewed, receiving position information indicating a position where the items are viewed, and storing the item identifier, count information and position information associated with the container information.

Example 10 is a computer-implemented method of any or all of the previous examples, and further including transmitting all information associated with the container information to a management system.

Example 11 is a computer-implemented method of any or all of the previous examples, wherein receiving position information includes automatically obtaining geolocation information.

Example 12 is a computer-implemented method of any or all of the previous examples, wherein automatically obtaining geolocation information includes obtaining geolocation information from a plurality of sources.

Example 13 is a computer-implemented method of any or all of the previous examples, wherein the plurality of sources includes global positioning information, Wi-Fi triangulation, and cellular triangulation.

Example 14 is a computer-implemented method of any or all of the previous examples, wherein position information is based on geolocation information from at least a plurality of sources.

Example 15 is a computer-implemented method of cycle counting. The method includes receiving discrepancy information, receiving geolocation information relative to the discrepancy information, and generating a navigation output based on a current position and the geolocation information.

Example 16 is a computer-implemented method of any or all of the previous examples, wherein the navigation output includes a heading.

Example 17 is a computer-implemented method of any or all of the previous examples, wherein the heading is included in an augmented reality display.

Example 18 is a computer-implemented method of any or all of the previous examples, and further including displaying an image relative to the geolocation.

Example 19 is a computer-implemented method of any or all of the previous examples, and further comprising receiving count information relative to the discrepancy in order to resolve the discrepancy.

Example 20 is a computer-implemented method of any or all of the previous examples, wherein the navigation output includes a distance between the current position and the geolocation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for reconciling physical items in a facility, the system comprising:
a data store containing item information relative to items stored within the facility;
a processor coupled to the data store, the processor being configured to perform at least one control function relative to the items;
a user interface component coupled to the processor and configured to receive information defining a cycle count relative to at least some items stored within the facility;
a network component coupled to the processor and configured to convey container information to a plurality of terminals based on the defined cycle count;
a virtual count engine configured to receive observation data from the plurality of terminals associated with the container information, the virtual count engine being configured to group the observation data according to item identifiers and compare the grouped information with information maintained in the data store.

2. The system of claim 1, wherein the observation data includes count information relative to a unique item identifier as well as location information indicative of a position where the count was observed.

3. The system of claim 2, wherein the location information is geolocation information.

4. The system of claim 3, wherein the system is configured to generate a discrepancy list based on the comparison.

5. The system of claim 4, wherein the discrepancy list includes geolocation information relative to each discrepancy.

6. The system of claim 1, wherein the user interface component is configured to generate a user interface element that when actuated causes the system receive observation data from the plurality of terminals and group the observation data according to unique item identifiers.

7. The system of claim I, wherein the container information is indicative of a cycle count relative to less than all of the items in the facility.

8. The system of claim 7, wherein the cycle count is defined for a region of the facility.

9-20. (canceled)

21. The system of claim 1, wherein the network component is configured to communicate with the plurality of terminals through an encrypted communication channel.

22. The system of claim 21, wherein the encrypted communication channel includes a virtual private network.

23. The system of claim 1, wherein the system is located on the premises of the facility.

24. The system of claim 1, wherein the system is a cloud implementation spaced from the facility.

25. The system of claim 1, wherein the at least one control function includes storage and maintenance of physical items in the facility.

26. The system of claim 1, wherein the virtual count engine in configured to define virtual count task information and wherein the container information includes the virtual count task information.

27. The system of claim 26, wherein the virtual count task information is defined relative to a subgroup of items stored within the facility.

28. The system of claim 27, wherein the subgroup is defined relative to a type of item stored within the facility.

29. The system of claim I, wherein the system is configured to generate a discrepancy list based on the comparison and provide the discrepancy list as an output to a worker in order to guide the worker to a location to resolve the discrepancy.

30. The system of claim 29, wherein the output is provided on a user interface of the system.s

31. The system of claim 29, wherein the output is provided through the network component to one of the plurality of terminals.

32. The system of claim 29, wherein the discrepancy report groups the items by worker.
